(19) United States
(12) Patent Application Publication
(10) Pub. No.: US 2003/0214439 A1
(43) Pub. Date: Nov. 20, 2003

(54) Low cross-polarization microstrip array

(76) Inventor: Donald A. Huebner, Larkspur, CO (US)

Correspondence Address: ANCEL W. LEWIS, JR., 425 WEST MULBERRY, SUITE 101, FORT COLLINS, CO, 80521, US

(21) Appl. No.: 10/152,086

(22) Filed: May 20, 2002

(51) Int. Cl. H01Q 1/38; H01Q 15/02

(52) U.S. Cl. 343/700 MS; 343/909; 343/753

(57) ABSTRACT

A low cross-polarization microstrip patch array antenna includes a microstrip patch array, an antenna substrate, a ground plane and a polarizer. The polarizer mounts over the array and includes a low dielectric spacer, a thin polarizer substrate mounted on the spacer and a plurality of uniformly spaced, thin, conductive strips on the polarizer substrate. The strips extend perpendicular to the direction of desired radiation and parallel to the direction of undesired radiation.

### TECHNICAL FIELD

The present invention relates to antennas and more particularly to a strip polarizer for microstrip patch array antennas and a microstrip patch array antenna with strip polarizer.

### BACKGROUND ART

All antennas are polarized, since polarization is determined by the direction of the electric field vector. For instance, car antennas which stick up vertically from the front fender region of the car are vertically polarized. Most television antennas consist of an assembly of parallel, horizontal tubes, and are thus horizontally polarized. A non-polarized source would indicate that the electric field is in all directions. An example of a non-polarized source is the Sun. Antennas try to radiate all energy in one polarization, usually vertical, horizontal, or a combination of these. In order to perform optimally, both the transmit and receive antennas must have the same polarization.

Energy radiated in the polarization for which the antenna is designed is designated “co-polarized”. Radiation in the undesired polarization is designated “cross-polarized”. Cross-polarized radiation which is transmitted is not received by the other antenna in the link, and thus represents wasted energy. This loss of energy is undesirable. Undesirable cross-polarized radiation can come from both the patch radiators and the feed network used to distribute power within a microstrip array. Prior known microstrip antennas that exhibit low cross-polarized radiation are multilayered antenna structures that are relatively expensive and complex.

### DISCLOSURE OF THE INVENTION

A low cross-polarization microstrip patch array antenna includes a microstrip patch array, an antenna substrate, a ground plane and a polarizer. The polarizer includes a low dielectric spacer with a planar outer surface and a substrate with a plurality of uniformly spaced conductive strips on the outer surface. The polarizer is positioned over the microstrip patch array antenna with the strips oriented perpendicular to the direction of desired polarization and parallel to the undesired polarization.

### BRIEF DESCRIPTION OF THE DRAWINGS

Details of this invention are described in connection with the accompanying drawings that bear similar reference numerals in which:

FIG. 1 is a side elevation view of a microstrip patch array antenna with a polarizer embodying features of the present invention.

FIG. 2 is a top plan view of the strips and patch array of FIG. 1.

FIG. 3 is a perspective view of the polarizer of FIG. 1.

### DETAILED DESCRIPTION OF THE INVENTION

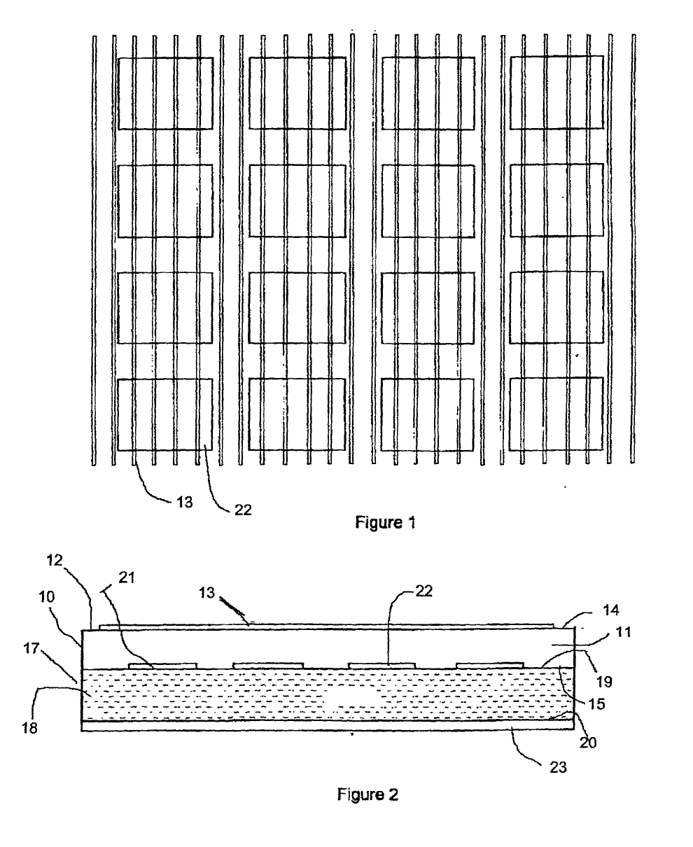

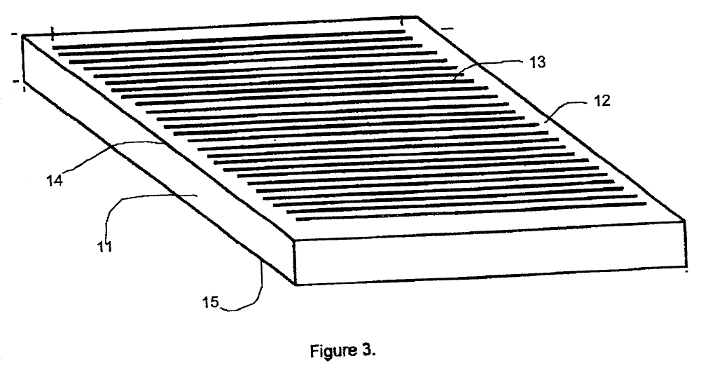

Referring now to FIGS. 1, 2 and 3, a polarizer 10 embodying features of the present invention includes a spacer 11, a polarizer substrate 12 and a plurality of narrow, elongated, conductive strips 13. The spacer 11 has a planar outer surface 14 and a spaced inner surface 15. The polarizer substrate 12 may be a thin film material such as Mylar. The strips 13 are parallel to each other and uniformly spaced on the polarizer substrate 12. The strips 13 may be formed by known printed circuit methods such as providing the polarizer substrate 12 as metal-clad and etching the metal-clad to form the strips 13. The polarizer substrate 12 is mounted to the outer surface 14 of the spacer 11.

The antenna 17 shown includes an antenna substrate 18 having an outer face 19 and a spaced inner face 20, a patch array 21 on the outer face 19 having a plurality of patches 22 and a ground plane 23 on the inner face 20. The polarizer 10 is sized and shaped to fit over the patch array 21 with the strips 13 extending beyond the patch array 21 in the direction parallel to the strips 13 and in the direction perpendicular to the strips 13. The polarizer 10 is mounted on the antenna 17 with the inner surface 15 of the spacer 11 on the patch array 21 and the outer face 19 of the antenna substrate 18, and with the strips 13 oriented perpendicular to the direction of desired polarization and parallel to the undesired polarization.

The width of each strip 13 and spacing between adjacent strips 13 depends on the frequency of operation of the antenna 17. The number of strips 13 per wavelength can vary from 5 to 20. Too few strips 13 leads to insufficient cross-polarization suppression, while too many strips 13 results in excessive capacitance between the strips 13 for the co-polarized radiation. The width of each strip 13 can vary from 0.05 to 0.25 of the spacing between the strips 13. The thickness of the spacer 11 can vary from 0.1 wavelengths (as measured in the dielectric material of the spacer 11) to 0.25 wavelengths. Excessively thick spacers 11 unnecessarily increase the total thickness of the microstrip array, while insufficiently thick spacers 11 create undesired interaction between the polarizer 10 and the underlying antenna 17. The dielectric constant of the spacer 11 should be less than 1.2 in order to minimize the effect of the spacer 11 on the antenna 17.

By way of example, and not as a limitation, a polarizer 10 for use in the 2.4-2.5 GHz industrial, scientific, and medical (ISM) frequency band may be dimensioned as follows. The spacer 11 is of Styrofoam and has a length of 13″, a width of 13″ and a thickness of 1″. There are 25 strips 13 uniformly spaced over 12″, and each strip 13 is ⅛″ wide and 12″ long. Only the dimensions of the polarizer 10 are listed since the polarizer 10 can be added to any microstrip patch array with the listed square size that operates in the ISM band and exhibits excessive cross-polarized radiation. The listed square size is typical for a microstrip array that exhibits 16-18 dBi of gain in this frequency band.

Several alternate embodiments exist for the polarizer 10 other than etching from a thin, copper clad substrate. The strips 13 can be die-cut from a copper sheet, with the undesired portion of the sheet removed and the strips held in place on the low-dielectric spacer 11 by an adhesive. The strips 13 can also be copper wires with the copper wire being attached to the low dielectric constant spacer 11 by means of an adhesive. In this case, suitable wire radii can be determined by noting the relation A=W/4, where A is the wire radii and W is the equivalent strip width.

The strips 13 serve to reflect or short-circuit the undesired polarization while letting the desired polarization pass through with minimal degradation. The polarizer 10 can be incorporated as part of the original design of an antenna. Conversely, the polarizer 10 can be added afterwards if an original microstrip patch array design is found to exhibit unacceptably high levels of cross-polarized radiation.

Although the present invention has been described with a certain degree of particularity, it is understood that the present disclosure has been made by way of example and that changes in details of structure may be made without departing from the spirit thereof.

What is claimed is:

1. A low cross-polarization microstrip patch array antenna, having a nominal frequency and wavelength of operation, comprising:
an antenna substrate having an outer face and a spaced inner face,
a patch array on said outer face having a plurality of spaced microstrip patches,
a ground plane on said inner face,
a low dielectric spacer sized and shaped to fit over said array and having a planar outer surface and an inner surface spaced a selected thickness from said outer surface, said inner surface being mounted over said array on said outer face of said antenna substrate, and
a plurality of elongated, conductive strips on said spacer, said strips having a selected width and being uniformly spaced with a selected spacing between adjacent said strips, said strips extending beyond said array in a direction parallel to said strips and in a direction perpendicular to said strips.

2. The antenna as set forth in claim 1 including a polarizer substrate mounted on said spacer with said strips being printed on said polarizer substrate with printed circuit methods.

3. The antenna as set forth in claim 2 wherein said polarizer substrate is a thin film material.

4. The antenna as set forth in claim 3 wherein said thin film material is Mylar.

5. The antenna as set forth in claim 2 wherein said polarizer substrate is initially a copper clad substrate with a copper layer and said strips are etched from said layer.

6. The antenna as set forth in claim 1 wherein said strips are die cut from a copper sheet and adhesively mounted on said spacer.

7. The antenna as set forth in claim 1 wherein said strips are copper wires adhesively mounted on said spacer.

8. The antenna as set forth in claim 1 wherein said spacer has a dielectric constant less than 1.2.

9. The antenna as set forth in claim 1 wherein said selected spacing is from 0.05 to 0.20 times said wavelength.

10. The antenna as set forth in claim 1 wherein said selected width is from 0.05 to 0.25 times said selected spacing.

11. The polarizer as set forth in claim 1 wherein said selected thickness is from 0.1 to 0.25 times said wavelength.

12. A low cross-polarization microstrip patch array antenna, having a nominal frequency and wavelength of operation, comprising:
an antenna substrate having an outer face and a spaced inner face,
a patch array on said outer face having a plurality of spaced microstrip patches,
a ground plane on said inner face,
a dielectric spacer having a dielectric constant less than 1.2, and sized and shaped to fit over said array, said spacer having a planar outer surface and an inner surface spaced a selected thickness of from 0.1 to 0.25 times said wavelength from said outer surface, said inner surface being mounted over said array on said outer face of said antenna substrate,
a polarizer substrate of a thin film material sized and shaped to fit over said outer surface and mounted thereon and
a plurality of elongated, conductive strips printed on said polarizer substrate with printed circuit methods, said strips being uniformly spaced with a selected spacing between adjacent said strips of from 0.05 to 0.20 times said wavelength and having a selected width of from 0.05 to 0.25 times said selected spacing, said strips extending beyond said array in a direction parallel to said strips and in a direction perpendicular to said strips.

13. A polarizer for an antenna having a microstrip patch array, said antenna having a nominal frequency and wavelength of operation, comprising:
a low dielectric spacer sized and shaped to fit over said array and having a planar outer surface and an inner surface spaced a selected thickness from said outer surface,
a plurality of elongated, conductive strips on said polarizer substrate, said strips having a selected width and being uniformly spaced with a selected spacing between adjacent said strips, said strips extending beyond said array in a direction parallel to said strips and in a direction perpendicular to said strips.

14. The polarizer as set forth in claim 13 including a polarizer substrate sized and shaped to fit over said outer surface of said spacer and mounted on said outer surface with said strips being printed on said polarizer substrate with printed circuit methods.

15. The polarizer as set forth in claim 14 wherein said substrate is a thin film material.

16. The polarizer as set forth in claim 15 wherein said thin film material is Mylar.

17. The polarizer as set forth in claim 14 wherein said substrate is initially a copper clad substrate with a copper layer and said strips are etched from said layer.

18. The polarizer as set forth in claim 13 wherein said strips are die cut from a copper sheet and adhesively mounted on said outer surface of said spacer.

19. The polarizer as set forth in claim 13 wherein said spacer has a dielectric constant less than 1.2.

20. The polarizer as set forth in claim 13 wherein said selected spacing is from 0.05 to 0.20 times said wavelength.

21. The polarizer as set forth in claim 13 wherein said selected width is from 0.05 to 0.25 times said selected spacing.

22. The polarizer as set forth in claim 13 wherein said selected thickness is from 0.1 to 0.25 times said wavelength.

23. A polarizer for an antenna having a microstrip patch array, said antenna having a nominal frequency and wavelength of operation, comprising:
a dielectric spacer having a dielectric constant less than 1.2, and sized and shaped to fit over said array, said spacer having a planar outer surface and a inner surface spaced a selected thickness of from 0.1 to 0.25 times said wavelength from said outer surface, said inner surface being suitable for mounting over said array,
a polarizer substrate of a thin film material sized and shaped to fit over said outer surface and mounted thereon and
a plurality of elongated, conductive strips printed on said polarizer substrate with printed circuit methods, said strips being uniformly spaced with a selected spacing between adjacent said strips of from 0.05 to 0.20 times said wavelength and having a selected width of from 0.05 to 0.25 times said selected spacing, said strips extending beyond said array in a direction parallel to said strips and in a direction perpendicular to said strips.
